(19) United States
(12) Patent Application Publication
(10) Pub. No.: US 2009/0059861 A1
(43) Pub. Date: Mar. 5, 2009

(54) BLIND HANDOVER USING LOAD COMPENSATED MEASUREMENTS

(75) Inventors: Fredrik Gunnarsson, Linkoping (SE); Walter Muller, Upplands Vasby (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON, Stockholm (SE)

(21) Appl. No.: 11/793,420

(22) PCT Filed: Dec. 21, 2004
(86) PCT No.: PCT/SE2004/001993

§ 371 Date: Oct. 16, 2008

(51) Int. Cl. H04W 36/00

(52) U.S. Cl. 370/331; 370/332

(57) ABSTRACT

A method of initiating handover in a cellular radio system with CDMA access technology. A mobile station is present in a serving cell and handover should be made from a serving cell to a target cell. Before the handover is made the signal quality from the target cell is estimated. The mobile measures the signal quality, preferably Ec/Io of the pilot tone, from the serving cell. An RNC node calculates the estimated signal quality as a function of the measured signal quality, a load dependent quantity at the serving and target cells and decides to initiate the handover when the estimated signal quality at the target cell is better than a predefined minimum value or is better than the measured signal quality. As load dependent quantity the total output transmission powers Pₛ and Pₜ may used.

### TECHNICAL FIELD OF THE INVENTION

The invention relates to cellular radio systems in general and to a method of inter-frequency handover in a cellular radio system with CDMA access technology in particular.

### DESCRIPTION OF RELATED ART

Handovers are employed in wireless cellular and personal communications systems to allow mobile stations to travel from the coverage area of one base station to another while maintaining a call. While handovers are usually employed to transfer an ongoing communication with the mobile station from a current to a new base station, it is also possible to hand over a communication with the mobile station from one set of forward and reverse links to another of the same base station.

In a CDMA system a handover of a mobile station between base stations can be either a soft handover or a hard handover.

Inter-frequency handover is typically a hard handover procedure by which a mobile station is switched or transferred from one set of forward and reverse communication links on one operating frequency to another set of forward and reverse communication links on another operating frequency.

When a handover is about to be made in accordance with prior art the mobile takes signal strength measurements of signals from adjacent candidate base stations (or adjacent candidate base stations take signal measurements of a signal from the mobile) and use these to decide to which base station handover should be made.

In a WCDMA system, wherein all communications take place on one and the same operating frequency, Mobile measurements of the signal strength or signal quality of candidate base stations which use a frequency different from said one and the same operating frequency is typically associated with a cost. A measurement taken on a frequency different from the actual operating frequency may impair the service, decrease data throughput or require extra transmission power on the actual operating frequency in order to maintain the connection.

Inter-frequency handovers in cellular CDMA systems may also be used in the following scenario: As the traffic load increases in a local area comprising existing “old” cells, all operating at an existing “old” frequency, the system operator may decide to configure and add a new cell on a new frequency in order to increase the traffic capacity. Initially the new cell may provide the same services and provide the same resources as the old cells. As technology evolves over time it may be desired to let the new cell realise the old services more efficiently, or let the new cell realise the old service with new technology or let the new cell realise a new service. New technology may require new hardware. For cost reasons a system operator therefore introduces new hardware in the new cell only, not in all of the existing “old” ones. In this way the new service or the new manner in which a service is realised is made available to a large population.

To find a site for the new base station of the new cell is called site acquisition. In urban areas site acquisition is difficult because favourable sites are already occupied by other radio systems. Therefore, a new bas station is often co-located with an “old”, implying that the new base station hardware is arranged in an empty space at the “old” base station and that the antenna of the new base station is a arranged at the same mast or pole as the antenna of the existing base station.

When a network is built cell planning is made and measurements and theoretical calculations of coverage areas of the antennas of each base station are made. In case of co-sited antennas there may be some overlap between the coverage area of the antennas of one cell layer and the coverage area of the antennas of the other co-sited cell layer Such overlap is referred to as “coverage relation” in this description and is configured into the radio systems. In a WCDMA system this information would be known to the radio network control (RNC) node.

The border of a cell is given by a zone wherein the radio signal strength or signal quality to the base station of an adjacent cell is better than what it is to the base station currently serving the mobile. The boarder of a cell defined by signal quality is dynamic, i.e. it changes all the time, since mobiles within a cell move and experience varying radio conditions requiring adjustments of the output power of its transmitter and also of the output power of the transmitter of base station. Further, new mobiles enters the cells and old mobiles leave the cell, this also requiring frequent adjustments of the power level of the base station. The dynamic nature of the cell border (=the coverage area of the cell or the radius of the cell) is typically dependent on power usage in the cell and is referred to as “cell breathing”.

Adjustments of the transmission power of base stations will affect the respective cell radii in different ways depending on whether or not a mobile has full coverage for the service it receives. If the mobile full has coverage, implying that the service it receives is independent of how high the base station transmission powers are, the mobile will obtain an acceptable service quality from at least one cell independently of the mobile's position. In this case, that is in the full coverage case, the cell border will not be affected by adjustments of base station transmission powers. The interference level however, will be affected and therefore the cell radius will be locally affected. If a mobile hasn't full coverage, then the coverage will be determined (a) by the mobile's distance, when it is transmitting at its maximum power, to the base station and (b) the base station's distance, when it is transmitting with maximum power, to the mobile. The shortest of these distances that provides an acceptable service quality to the mobile irrespective of interference from neighbouring base stations or mobiles will determine the coverage. Thus, when the transmission power of a base station varies in the non-coverage case the cell radius of the base station will also vary.

The present invention starts from the fact that the new cells provide a new service or provide a service more efficiently. The old and new cells are thus different in terms of the services they support or the manner in which services are supported. Old mobile stations cannot support the new service or the new manner in which services are supported. New mobile stations are thus required for the new services or for supporting the new manner in which services are provided. New cells may also be added in order to balance traffic load.

Inter-frequency handovers have an inherent higher risk for causing dropped call causing annoyance and inconvenience to the parties involved in the dropped call.

One method of improving the reliability of an inter-frequency handover is to increase the spreading factor during the handover as described in U.S. Pat. No. 6,741,577. Another method is to evaluate the quality of a second frequency by using offset adjusted measurements on a first frequency as described in U.S. Pat. No. 6,546,252. In U.S. Pat. No. 6,681,112 an inter-frequency handover method is described wherein the signal strength RSSI is measured on the frequency to which handover is made, that is directly on the target carrier. This RSSI measurement takes less time than measuring signal strength or signal quality thereby avoiding service and load impact by performing measurements.

### SUMMARY OF THE INVENTION

One object of the present invention is to provide a method for initiating an inter-frequency handover from a first frequency, called the serving carrier frequency or simply serving carrier, to a second frequency, called the target carrier frequency or target carrier, without requiring the mobile to measure on the target frequency. For this reason the handover is referred to as a “blind”.

Another object of the invention is to estimate the quality of the target frequency and take a handover decision when the estimated quality indicates the mobile is within the coverage area of the base station transmitting the target carrier.

Another object of the invention is to provide for initiating a blind inter-frequency handover from a serving carrier to a target carrier by measuring a load and coverage dependent quantity on the serving carrier, and by compensating the load and coverage dependent quantity by the relative load on the target carrier and the serving carrier and use this information as basis for taking the handover decision.

The inter-frequency handover in accordance with the invention shall be seamless in the sense that the communication between the mobile and the base station at the first frequency before the handover and the mobile and the base station at the second frequency after the handover shall not be significantly interrupted and QoS provided by the second base station after the handover should be at least the same as the QoS provided by the first base station before the handover.

Still another object of the invention is to provide a method for initiating a blind inter-frequency handover for traffic distribution purposes e.g. from a micro cell (transmitting on a serving carrier) of a WCDMA system to a macro cell covering the micro cell (transmitting on a target carrier of the same frequency as the serving carrier) of the same WCDMA system without requiring the mobile to take measurements on the target carrier.

### BRIEF DESCRIPTION OF THE DRAWING

FIG. 1. is a schematic view of two co-located base stations and a mobile station, and

FIG. 2. is a flow diagram illustrating the method in accordance with the invention.

### DETAILED DESCRIPTION OF EMBODIMENTS

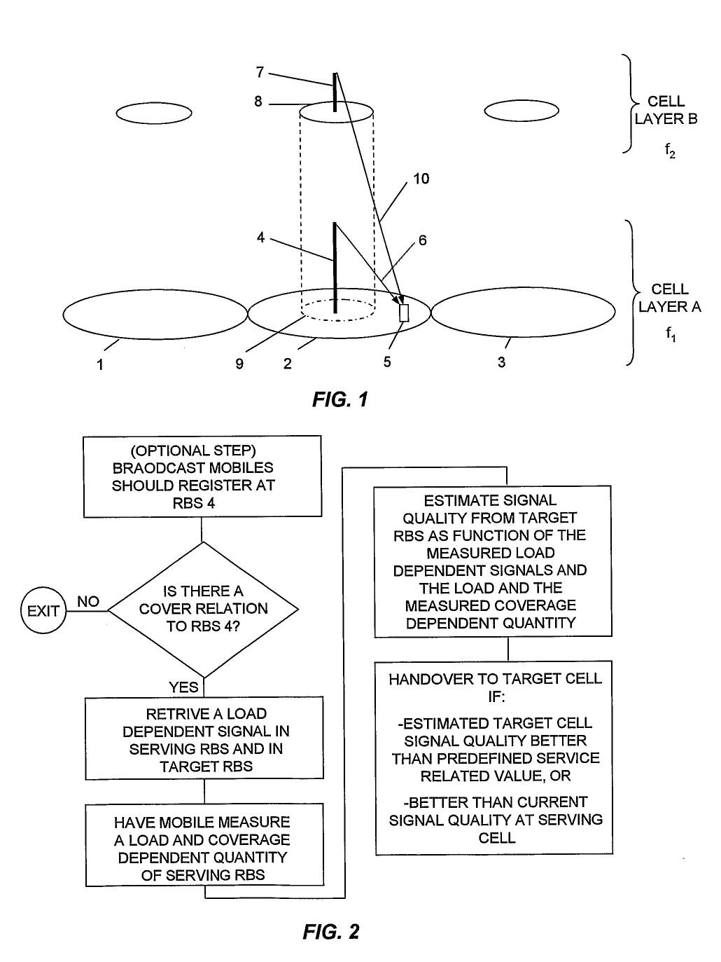

In FIG. 1 a cell layer A is a WCDMA based radio system operating on a first carrier frequency f₁. The cell layer A comprises a plurality of cells of which only three, 1-3, are shown. Each cell has a base station site comprising a housing for transmitters, receivers, power supply units and a nearby tower or pole on which antennas are mounted. Sector antennas or antenna arrays providing directivity are often used. For clarity reasons only cell 2 is shown with a base station, symbolically shown at 4. A mobile station 5 moving within cell 2 has a radio connection with the base station 4 over a radio path 6.

The network operator of the cell layer A has co-located a base station 7 at the base station site of base station 4. The antennas of the base station 7 are sitting at the same tower as the antennas of the base station 4. The co-located base station is operating on a second carrier frequency f₂. Base station 7 is part of another WCDMA cell layer B as shown schematically in FIG. 1.

The mobile 5 is supposed to have the capabilities required to receive service from the base station 7.

Suppose the mobile 5 should make a handover from base station 4 to the base station 7. Cell 4 is thus the serving cell and its base station is transmitting on the serving carrier f₁. Cell 7 is the target cell and its base station 7 is transmitting on the target carrier f₂.

Also suppose the mobile is in its idle state in the serving cell and wants to set up a session. It therefore sends a call request to the base station 4. A call request contains, according to the 3G standards, many different kinds of information, among these information indicative of the fact that the mobile is able to execute a new service or is able to realise a new service. The base station forwards the call request to a radio network control (RNC) node controlling the cells of cell layer A. When the RNC node receives the call request the network will know about the mobile with the new capabilities. The RNC node can now also verify that the mobile is on frequency f₁, which is the wrong frequency if it should receive the service of base station 7.

A problem now arises, since the RNC cannot be sure the mobile will receive service from the target base station 7 if handover is done right away without any restrictions. A seamless handover is desired, but since cell areas and carrier power change dynamically and the mobile has one and the same given geographical position in relation to the serving and target base stations 7 the RNC cannot guarantee seamless handover if the situation for example is the one shown in FIG. 1, where the mobile is within cell 2 near its outer border but outside the coverage area of the target cell 8, this coverage area being the area of circle 9.

In the situation shown in FIG. 1 there are no neighbouring cells in cell layer B that cover the geographical position of mobile 5. On the contrary, there are “dead” areas between the cells of cell layer B as illustrated.

It would be an easy matter for the mobile 5 to measure the quality of target carrier, but as indicated above this is a costly operation. In accordance with the invention the quality of the target carrier is instead estimated using the following scheme in accordance with the invention:

As a first, optional, step the broadcast signal from base stations in cell layer A is complemented with information that tell all mobiles to register their presence in the base stations of cell layer A. The broadcast signal from base station 4 tells the mobiles the identity of cell 2 and a threshold value a mobile's signal must exceed in order for it to select cell 2 as serving cell. Further, the broadcast signal from base station 4 tells the mobiles of the existence of neighbouring cells, in this case cells 1 and 3 and their respective threshold values. In this manner it will be possible to control mobiles like a pack (of animals for example) and tell the pack where to go, in this case cell layer A because all mobiles are supposed to support the services of this cell layer, but all mobile do not support services of cell layer B.

As a first mandatory step in accordance with the invention the RNC, upon reception of a call request signal, checks if there is a cover relation at the base station from which the call request signal was received. As noted above information relating to cover relation is configured into the network. If there is a cover relation the second mandatory step in accordance with the invention is taken. If there is no cover relation, then no further steps in accordance with the invention are taken and no handover in accordance with the invention is made.

As a second mandatory step in accordance with the invention a quantity that reflects the load of the base station of the serving cell and the load of the base station of the target cell is monitored in real-time. An example of one such quantity is the total output power Pₛ of the serving carrier and the total output power Pₜ of the target carrier. Other examples of a load dependent quantity are described below.

The RNC knows about the serving cell's total output power. It receives this information over the interface from base stations it serves. An RNC in cell layer B will also receive the output power currently used at each of the base station it serves. In particular the RNC signals the output power of the target cell to the RNC in cell layer A over a signalling link between cell layers A and B.

The total output power of base station is a load measure. A high output power is a typical indication of a high load (in terms of number of users) of a cell. If a cell, for example cell 2 in FIG. 1, has a high load this is caused by the transmissions form neighbouring cells, for example cells 1 and 3, which are transmitting with a high power on the same frequency thus causing interference in the down link to the mobile in the 2. Cell 2 tries to compensate the interference by increasing its transmission power in the down link correspondingly.

From this discussion it appears that it is not sufficient to use the output power of the target cell as a single basis for a hand over (HO) decision, because if the load is high, there is a risk the mobile jumps into a dead zone (=the non-coverage case discussed above). Further, the mobile takes no measurements on the target cell.

As a third mandatory step in accordance with the invention a quantity which is load and coverage dependent is measured on the serving carrier. This measurement is taken by the mobile and gives as result a quality related coverage of the serving cell. An example is to measure the SIR of the pilot tone from the serving cell. The SIR of a pilot tone is measured as CPICH E_{c}/Iₒ in accordance with the 3G standard. CPICH is an acronym for common pilot channel, E_{c} reflects useful RF energy from the base station and is measured at the mobile. The Iₒ term reflects the sum of the interferences from surrounding base stations as measured in the mobile. Such CPICH E_{c}/Iₒ measurements are taken by the mobile and are reported to the RNC in the connection request message which is transmitted over the interface. The pilot tone from a cell is transmitted with constant output power and is independent of the varying total output power. If the load on the cell increases interference will increase and the SIR value of pilot tone will decrease, indicating a decreasing quality. We want to get rid of the load dependence of the SIR value as measured from the base station of the serving cell since it does not tell us anything of the situation prevailing at the target cell. Later on we want to introduce the load dependence of the SIR value at the target cell and thereby achieve an estimated quantity that reflects the load and the coverage at the base station of target cell.

To begin with we eliminate the load dependence of the (SIR)ₛ quotient (E_{c}/Iₒ)ₛ by multiplying it with (Iₒ)ₛ:

$${( \frac{{E}_{c}}{{I}_{0}} {I}_{0} )}_{S} = {E}_{c}$$

which gives us the useful RF power, a quantity that is generally dependent of the mobile's location within the serving cell, that is a quantity that reflects the path attenuation. Index s relates to serving cell.

However, we cannot measure Iₒ as such. But we know there exists a relation between the useful RF power Pₛ and (SIR)ₛ. This relation may not necessarily be proportional, but we assume it is so and therefore we obtain the relation

(Iₒ)ₛ≈αPₛ Eq. 1

where α is a proportionality factor, index s relates to serving cell and index t relates to target cell.

As a fourth mandatory step in accordance with the invention the quality related coverage as measured by the mobile in the third mandatory step is compensated by the relative load on the target carrier and the serving carrier and the result is an estimated quality related coverage of the target cell.

We now want to re-introduce the load dependant part of the SIR, this time in the SIR of the target cell. We will then have to divide E_{c} in Eq. 1 by (Iₒ)ₜ. Since we do not know (Iₒ)ₜ as such we use a similar relation between (Iₒ)ₜ and total transmission power Pₜ at the target cell (Iₒ)ₜ≈α′Pₜ in order to obtain

$${( \frac{{E}_{c}}{{I}_{o}} )}_{t} = {( \frac{{E}_{c}}{{I}_{0}} )}_{s} \cdot \frac{{( {I}_{0} )}_{s}}{{( {I}_{0} )}_{t}} = {( \frac{{E}_{c}}{{I}_{0}} )}_{s} \cdot \frac{α {P}_{s}}{{a}^{′} {P}_{t}}$$

Assuming that α and α′ are about equal one can then write

$${( \frac{{E}_{c}}{{I}_{o}} )}_{t} \approx {( \frac{{E}_{c}}{{I}_{0}} )}_{s} \cdot \frac{{P}_{s}}{{P}_{t}} \qquad Eq . 2$$

The SIR of the target cell may then be written:

$${( SIR )}_{t} = {( SIR )}_{s} ( \frac{{P}_{s}}{{P}_{t}} ) \qquad Eq . 3$$

Taking the logarithm of both sides and expressing the result in dB gives:

(SIR)ₜ=(SIR)ₛ+Pₛ−Pₜ Eq. 4

Mathematically the estimated signal quality from the target cell may be written

(SIR)ₜ=g₂(g₁((SIR)ₛ, Pₛ), Pₜ) Eq. 5

wherein (SIR)ₛ is the signal-to-interference ratio of a pilot tone transmitted from the base station (4) of the serving cell,
g₁ is a function that aims at eliminating the load dependence on (SIR)ₛ from Pₛ,
g₂ is a function that aims at adding the load dependence on (SIR)ₛ from Pₜ,
Pₜ is the total transmitted power from the target cell, and
Pₛ is the total transmitted power from the serving cell.

The result is used as basis for taking a HO decision from the serving carrier to the target carrier. The fourth step executes in cell layer A, preferably in a RNC node.

The inventive method uses the fact that the antennas of the service and target cells are located at the same site, which means that the attenuation in radio path 6 between the antenna in the serving cell and the mobile is the same as the attenuation in the radio path 10 between the target cell and the same mobile is the same provided the load of the two cells and therefore also the SIRs on the cells are the same. Typically the loads on the cells differ. The load difference between the target and serving cells would therefore equal the SIR difference between target and serving cells.

If the mobile measures the SIR (E_{c}/Iₒ of the pilot tone) on the serving cell it is possible to estimate the SIR of the target cell by compensating the measured SIR of the serving cell with the load difference between the target and serving cells.

As mentioned above the coverage varies with the load (the transmission power in the downlink) and therefore a difference in the load will also be a measure of the difference in coverage.

Note that mobiles far away from a serving cell will be closer to cells that interfere with the serving cell. Loss of coverage may therefore take place for two reasons:

(a) Increased path attenuation to the mobile. The signal strength from the mobile will thus decrease.

(b) Increased interference at the mobile because the mobile is close to interfering cells. The interference power at the mobile will thus increase. Reasons (a) and (b) taken together will result in a decreased SIR at the mobile.

Eq. 4 can be written:

(E_{c}/Iₒ)ₜ+Pₜ=(E_{c}/Iₒ)ₛ+Pₛ Eq. 6

which says that if the sum of the load and interference at the serving cell equals the sum of the load and interference at the target cell, then a mobile that has a certain quality of service QoS in the serving cell is likely to have the same QoS in the target cell 8.

As a fifth mandatory step in accordance with the invention handover is made if any of the two following conditions are fulfilled:

If the estimated SIR in the target cell has at least a minimum predefined SIR for the service in question, that is (CPICH E_{c}/Iₒ)ₜ≧(CPICH E_{c}/Iₒ)ₘᵢₙᵢₘᵤₘ. Different services may have different minimum SIR values.

If the estimated SIR in the target cell is better then the SIR in the serving cell. For example the estimated SIR shall be at least 3 dB better than the actual SIR in the serving cell 2.

For HO to take place it is of course required the mobile is of a type that has the capabilities required to be served by the target cell. The mobile sends information on its capabilities to the RNC in the call request message.

FIG. 2 illustrates the steps discussed under the headings above in a flow diagram. In the diagram RBS is an abbreviation for radio base station.

### ALTERNATIVE EMBODIMENTS

Instead of using the total output transmission powers from the target and serving base stations as parameters in the estimation of the signal quality from the base station other quantities that relate to the load of a base station may be used, for example code tree utilisation at the serving and target carriers.

Some wireless systems are based on orthogonal variable spreading factor (OVSF) codes. The codes are mutually orthogonal, and the codes are constructed like a binary tree, where each node has two branches. The top node is divided into two branches each one connected to a respective node. These are the spreading factor 2 codes. One step further down, there are four codes with spreading factor 4, then eight codes with spreading factor 8, etc. Far further down, there are 128 codes with spreading factor 128, which is the spreading factor of speech in WCDMA. When allocating one code to a connection, all nodes below the allocated node become occupied. The code tree utilization can be expressed as the sum over the inverse of the spreading factor (sf) of all allocated codes. For example, the code tree utilization of seven services with sf 128, one with sf 32 and two with sf 8, equals

(7·1/128)+(1·1/32)+(2·1/8)=43/128

which is approximately 0.34.

Still another load dependent quantity is the ASE at serving and target carriers. ASE is an abbreviation for approximate speech equivalent and is an estimation of the costs of a service normalized on the speech cost expressed in terms of radio resources. Instead of Pₜ and Pₛ in the equations above, except in Eq. 4, the corresponding parameter should be used.

In an alternative embodiment of the invention cell layer B may operate at the same frequency as cell layer A. For example cell layer A provide micro cells, while cell layer B provide macro cells.

In still another embodiment of the invention cell layer A and B operate on the same frequency and HO to cell layer B is made in order to share load between base stations 4 and 7.

In still another embodiment, which may be combined with preferred embodiment and/or any of the two first mentioned alternative embodiments there is a non-shown third cell layer C with base stations and the inventive method is applied on target base stations in cell layers B and C, giving two estimated quality values. Handover is made to the target base station with the best estimated quality value.

Other nodes than RNC nodes can calculate the estimated signals quality value at the target base station.

In FIG. 2 the order in which the steps of “retrieving the total transmission powers in serving RBS and target RBS” and “have mobile measure SIR of pilot tone of serving RBS” are executed may be reversed.

It should be noted that the order in which the second and third mandatory steps are performed may be reversed.

From the above it is clear the invention is resource configuration based since it requires that there is a configured cover relation between the serving and target cells. At cells lacking a cover relation the invention is of no use. The invention is also service based since it applies only to a certain service. It does not apply to all services provided by a base station. Finally it is load based since the load of the target cell and the load of the serving cells are used in the handover decision.

1-19. (canceled)

20. A method of initiating handover in a cellular radio system including CDMA access technology and comprising first cells on a first frequency band and second cells on a second frequency band, each one of the cells being served by a respective base station, a mobile being served by a serving cell among the first cells and said handover taking place from the serving cell to a target cell among the second cells, comprising estimating the signal quality from the target cell as a function of a signal quality from the radio base station of the serving cell, a quantity related to the load of the radio base station of the serving cell and a quantity related to the load of radio base station of the target cell, and deciding to initiate handover when the estimated signal quality from the target cell is better than a predefined minimum value or is better than the measured signal quality.

21. A method in accordance with claim 20, wherein the signal quality from the serving cell is taken by the mobile station measuring the signal to interference ratio (SIR) of a pilot tone transmitted by the base station of the serving cell.

22. A method in accordance with claim 20, wherein the quantity related to the load of the serving and target cells is total output transmission power (Pₛ, Pₜ) or code tree utilisation or approximate speech equivalent (ASE).

23. A method of initiating handover in accordance with claim 22, wherein the estimated signal quality from the target cell is
(SIR)ₜ=g((SIR)ₛ, Pₛ, Pₜ)
wherein (SIR)ₛ is the signal-to-interference ratio of a pilot tone transmitted from the base station of the serving cell.

24. A method of initiating handover in accordance with claim 22, wherein the estimated signal quality from the target cell is
(SIR)ₜ=g₂(g₁((SIR)ₛ, Pₛ), Pₜ)
wherein (SIR)ₛ the signal-to-interference ratio of a pilot tone transmitted from the base station of the serving cell,
g₁, is a function that aims at eliminating the load dependence on (SIR)ₛ from Pₛ,
g₂ is a function that aims at adding the load dependence on (SIR)ₛ from Pₜ,
Pₜ is the total transmitted power from the target cell, and
Pₛ is the total transmitted power from the serving cell.

25. A method of initiating handover in accordance with claim 24, wherein the signal-to-interference ratio from the target cell is calculated according to the following:
(SIR)ₜ=(SIR)ₛ+(Pₛ−Pₜ)
all expressed in dB values, wherein (SIR)ₛ is the SIR of the pilot tone.

26. A method in accordance with claim 25, wherein the SIR of the pilot tone is a common pilot channel signal CPICH E_{c}/Iₒ indicative of the useful energy of the pilot signal in relation to the energy of the interference as measured at the mobile station.

27. A method in accordance with claim 20, comprising:
measuring, at the mobile station, the signal quality from the serving cell to obtain a measure of the coverage of the serving cell,
retrieving, from the radio system,
the total output transmission power used by the base station in the serving cell to obtain a quantity which is dependent of the load of the serving cell, and
the total output transmission power used by the base station in the target cell, thereby obtaining a quantity which is dependent of the load of the target cell,
estimating a measure of the coverage of the target cell by compensating the coverage measurement of the serving cell, as taken by the mobile station, with the load of the serving cell and the load of the target cell, and
deciding to initiate the handover when the estimated signal quality from the target cell is better than a predefined minimum value or is better than the measured signal quality.

28. A method in accordance with claim 27, comprising establishing a relation between the SIR of a pilot tone, as measured at a mobile station, broadcasted by a base station and the quality of a service accessible from the access cell layer, the relation being such that a predefined minimum signal quality value must be attained for the handover to be initiated, said relation being individual for each individual service accessible from the access cell layer.

29. A method in accordance with claim 27, comprising subtracting the transmission power (Pₜ) in dB of the base station of the target cell from the transmission power (Pₛ) in dB of the base station of the serving cell so as to obtain a measure of the difference in coverage between the serving cell and the target cell, and obtaining said estimated signal quality from the target cell by modifying the coverage of the serving cell, as measured by the mobile station, with the rest from the subtraction (Pₛ−Pₜ).

30. A method of initiating handover in accordance with claim 20, wherein base stations in the first cells are broadcasting a message to the mobile stations including inserting in the broadcast message an instruction to the mobile stations to initially select as serving cell one of the first cells.

31. A method of initiating handover in cellular radio system including CDMA access technology and comprising first cells on a first frequency band and second cells on a second frequency band, each one of the cells being served by a respective base station, a mobile being served by a serving cell among the first cells and said handover taking place from the serving cell to a target cell among the second cells, comprising estimating the signal quality from the target cell as a function of a signal quality from the radio base station of the serving cell, a quantity related to the load of the radio base station of the serving cell and a quantity related to the load of radio base station of the target cell, and deciding to initiate handover when the estimated signal quality from the target cell is better than a predefined minimum value or is better than the measured signal quality, comprising:
measuring, at the mobile station, the signal quality from the serving cell to obtain a measure of the coverage of the serving cell,
retrieving, from the radio system,
the total output transmission power used by the base station in the serving cell to obtain a quantity which is dependent of the load of the serving cell,
the total output transmission power used by the base station in the target cell, thereby obtaining a quantity which is dependent of the load of the target cell,
estimating a measure of the coverage of the target cell by compensating the coverage measurement of the serving cell, as taken by the mobile station, with the load of the serving cell and the load of the target cell, and
deciding to initiate the handover when the estimated signal quality from the target cell is better than a predefined minimum value or is better than the measured signal quality, also comprising:
deciding if there exists a configured cover relation between the serving cell and the target cell, and if so executing the steps of claim 27, else canceling the handover.

32. A method of initiating handover in cellular radio system including CDMA access technology and comprising first cells on a first frequency band and second cells on a second frequency band, each one of the cells being served by a respective base station, a mobile being served by a serving cell among the first cells and said handover taking place from the serving cell to a target cell among the second cells, comprising estimating the signal quality from the target cell as a function of a signal quality from the radio base station of the serving cell, a quantity related to the load of the radio base station of the serving cell and a quantity related to the load of radio base station of the target cell, and deciding to initiate handover when the estimated signal quality from the target cell is better than a predefined minimum value or is better than the measured signal quality, comprising:
measuring, at the mobile station, the signal quality from the serving cell to obtain a measure of the coverage of the serving cell,
retrieving, from the radio system,
the total output transmission power used by the base station in the serving cell to obtain a quantity which is dependent of the load of the serving cell,
the total output transmission power used by the base station in the target cell, thereby obtaining a quantity which is dependent of the load of the target cell,
estimating a measure of the coverage of the target cell by compensating the coverage measurement of the serving cell, as taken by the mobile station, with the load of the serving cell and the load of the target cell, and
deciding to initiate the handover when the estimated signal quality from the target cell is better than a predefined minimum value or is better than the measured signal quality, also comprising:
checking if the antennas of the radio base stations in the serving and target cells are co-located, and if so executing the steps of claim 27, else canceling the handover.

33. A method of initiating handover in accordance with claim 27, wherein a reason for making the handover is that the target cell comprises hardware and/or software supporting a new service not provided by the serving cell or comprises hardware and/or software which more efficiently execute a service provided by the serving cell.

33. A method of initiating handover in accordance with claim 27, wherein the reason for making the handover is to share the load with the serving cell.

34. A method in accordance with claim 27, wherein the first frequency band (f₁) is different from the second frequency band (f₂).

35. A method in accordance with claim 27, wherein the first frequency band (f₁) is the same as the second frequency band (f₂).

36. A method of initiating handover in accordance with claim 27, wherein the cellular radio system comprises third cells on a third frequency, the method further including initiating handover to a target cell among the third cells.

37. A method in accordance with claim 20, wherein the estimation of the signal quality from the target cell is made in a radio network controller (RNC) node in the access network, said radio network controller node also, in a manner known per se, monitoring, in real-time, the total transmitting powers (Pₛ, Pₜ) at the serving and target nodes.
